(19) United States
(12) Patent Application Publication
(10) Pub. No.: US 2016/0125496 A1
(43) Pub. Date: May 5, 2016

(54) SYSTEM AND METHOD OF TRADING COLLECTIBLE ITEMS

(71) Applicant: EDWARD THOMAS, Tinton Falls, NJ (US)

(72) Inventor: EDWARD THOMAS, Tinton Falls, NJ (US)

(21) Appl. No.: 14/530,797

(22) Filed: Nov. 2, 2014

(51) Int. Cl. G06Q 30/06

(52) U.S. Cl. CPC G06Q 30/0625; G06Q 30/0633

(57) ABSTRACT

A system and method which enables anyone possessing collectible items to trade, and exchange these collectable items with each other and document the transaction via the internet from anywhere around the world. The present invention enables users to identify which collectible items available for trade and assists in the coordination of the exchange/trade process. Currently collectors maintain a collection of items including but not limited to stamps, comic books, trading cards, dolls, watches, trading pins, luxury cars, etc.

### BACKGROUND

1. Field of the Invention

This application relates to a method and system which facilitates anyone possessing collectible items to trade these items with each other via an internet based service from an internet connection anywhere around the world.

Many collectors attend trade shows, conventions and other meeting events to view and trade their collectible items. Oftentimes, after the meetings/conventions are completed, which are sometimes annually or every four to five years, the opportunity to review other collector's collection is ended until next time. If there was a way to keep in touch with other collectors, view their collection, see what items they are willing to trade, that would be a great benefit. Collections include but not limited to stamps, comic books, trading cards, trading pins, art, dolls, jewelry, watches, etc. are commonplace today.

2. Description of the Related Art

Use of the internet to purchase products, communicate with others, trade stocks are commonplace today. Thee prior arts do not focus on trading or exchanging of collectible items between collectors. They focus on the sale of products or the trading of items such as stocks, where the buyer purchases stock from brokerage firms or in the sale of products within groups of users. In U.S. Pat. No. 8,812,392 B2 to Shahghasemi, there is shown a method and system for interacting and trading among users of online social commercial network, for currency. In U.S. Pat. No. 8,832,060 B2 to Sundaresan et al, there is shown a shopping context engine where there is use identifiable context data as a ranking methodology for identify user interests.

### SUMMARY OF THE INVENTION

The present invention is a method and system which enables anyone possessing collectible items to execute a trade of these items and document the transactions in a shared repository. An objective of the present invention is to enable users to log onto a website, or use an App to view existing collectible items. Additionally, enable the user to establish a personal collection profile reflecting of their existing collection. Another objective is to enable the user to trade/exchange items with others.

A further object of this invention is to enable authenticated users to select items from a Collections Items List (CIL) and add those items to the user's own collection profile, representing their current personal physical holdings.

Yet another object of this invention is to enable users to view the collection profile (or holdings) of other users when other user personal collection views are available.

Still another objective of this invention is to enable users to identify and change the status of items in their holdings reflecting their willingness to trade those items.

A further objective if this invention is to enable users to view items for trade by other users, and the option of making an offer for trade.

A still further object of this invention is to enable users to select from a Collections Items Menu (CIM), the name of a desired Collection. These Collections include but not limited to stamps, comic books, trading cards, trading pins, art, jewelry, watches, etc.

Still a further objective of this invention is to enable users to propose items to be added to the CIL and CIM.

Still another objective is to enable users to view their trading history and rate the exchange experience with other users.

Yet another objective is to ensure confirmation of exchange between the trading parties.

### BRIEF DESCRIPTION OF THE DRAWINGS

FIG. 1 is a representation of a global perspective view of the connectivity between users of the present invention;

FIG. 2 is a view of the initial computer browser options of the main user screen before and after login of the present invention;

FIG. 3 is a sample table view reflecting a user's Landing Page after login;

FIG. 4 is a view of the Collections Items Menu (CIM);

FIG. 5 is a sample table view showing all available offers from the various users of the present invention;

FIG. 6 is a sample table view showing a user's personal collection profile; and

FIG. 7 is a sample table view reflecting a user's acceptance of the exchange between the parties of the present invention.

### DETAILED DESCRIPTION

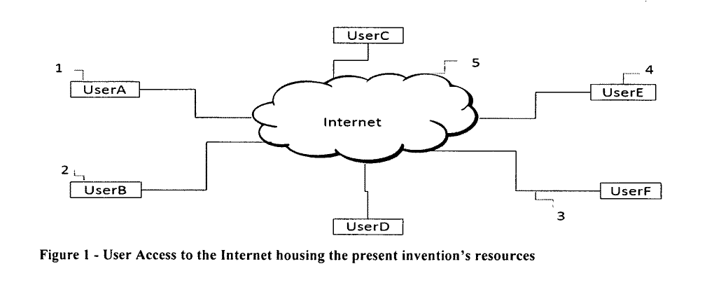

Referring to FIG. 1, users are able to gain access 3, via network connectivity to the present invention deployed on a web server on the internet 1. This enable users such as 1, 2, 3, 4 and all others users from all over the world to gain access and use the services of the present invention.

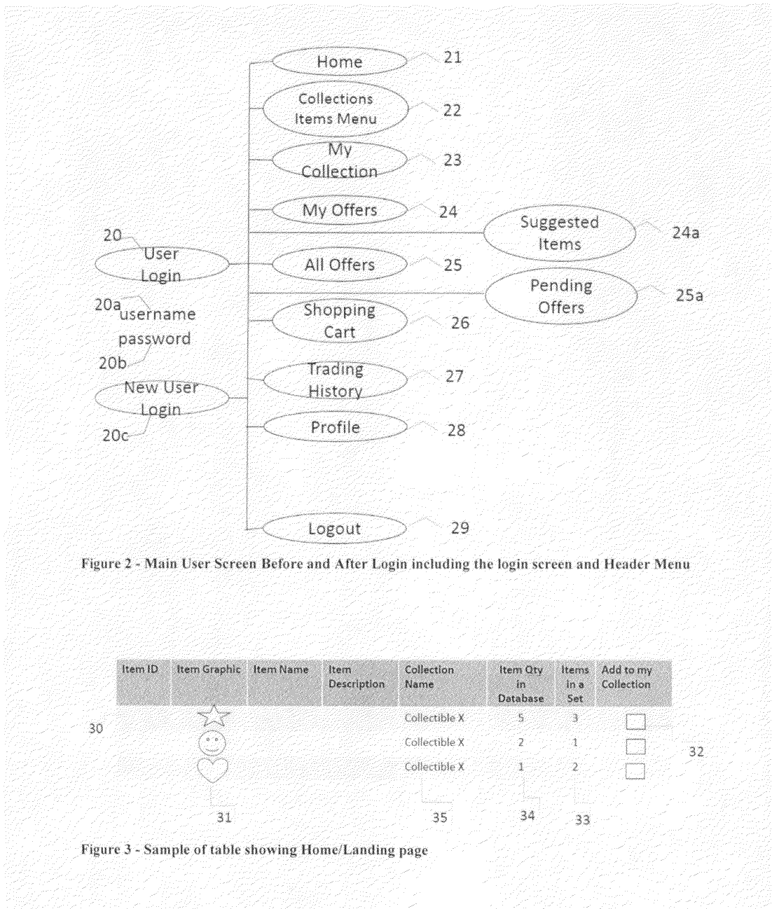

FIG. 2, shows access to the present invention by users entering their user credentials at the User Login 20 screen. By entering the correct username 20a and password 20b, the user gains access to the features of the present invention's menu 21-29. If incorrect user credentials are entered, the user will receive an error message. For new users 20c, they have the opportunity to enter their desired username and password. This username and password is stored in the database 37 for future access. After entering the correct login credentials, the user lands on the home/landing page 30, containing the Header Menu 21-29.

Additionally, the user will see the list of existing collections items (the CIL) 31, reflecting all items in the current collection. The CIL provides a display of item including; graphic, description, name, quantity 34, and groupings 33, and an opportunity to select a given collection item. Further, using keywords, users may search the collections database for targeted output, as well as obtaining a display to reflect the popularity of such collectible items.

By selecting the desired Item Selection 32, the user is able to choose items from the CIL to be added to their personal collection profile.

Using a similar process, users are able to delete items from their collections in the event the item is no longer in their possession; such as being lost, etc.

Further referring to FIG. 2, the user selects any of the main web pages 21-29. Initially, the My-Collection 23, My-Offers 24, the My-Shopping-Cart 26, and My-Trading-History 27, are empty, however, the All-Offers 25 page, reflects all available items identified by other users to be available for trade.

By selecting the Collections Item Menu (CIM) 22, the user is able to view and select any of the available Collection Names of the present invention, including but not limited to stamps, comic books, trading cards, trading pins, art, jewelry, watches, luxury cars, etc.

By selecting the My-Collection 23, the user is able to view items that they have identified to be in their personal possession.

By selecting the My-Offers 24, the user is able to view items they have identified that they are willing to trade/exchange with other users.

Additionally, by selecting Suggested-Items 24a, enables the user to propose items for possible inclusion to the CIL and CIM. Users may recommend items including uploading graphic, providing description, and item collection definitions.

By selecting the All-Offers 25, the user is able to view CIL identified by all other users, which they are willing to trade/exchange.

By selecting the All-Offers 25a, the user is able to view the status of exchange transactions;

By selecting the Shopping-Cart 26, the user is able to view both the items they are trading and the item they hoping to receive from the exchange. By clicking a submit button, an email is sent to both parties reflection a committed offer to trade/exchange. As an example, if UserA 1 wishes to trade a collection item with userB 2, then UserA, selects the proposed item 52 and makes a committed offer to userB. If B clicks and accepts the offer, an email is then sent automatically to both userA & userB reflecting the agreement to the exchange. Upon satisfaction, both userA and userB clicks on their respective Item-Acceptance 72 buttons, verifying the conclusion of the exchange process ensuring that both users are satisfied. Upon acceptance by both parties, the present invention updates both UserA and UserB's records reflecting completion of the exchange.

By selecting the Trading-History 27, the user is able to view a record of all previous trades/exchanges.

Selecting the Profile 28, enables the user to set user preferences; such as reset password, change default Collection Name, and setup payment method.

By selecting the Logout 29, enables the user to close the session and exit the services of the present invention. Subsequently a Login 20 is required for further access.

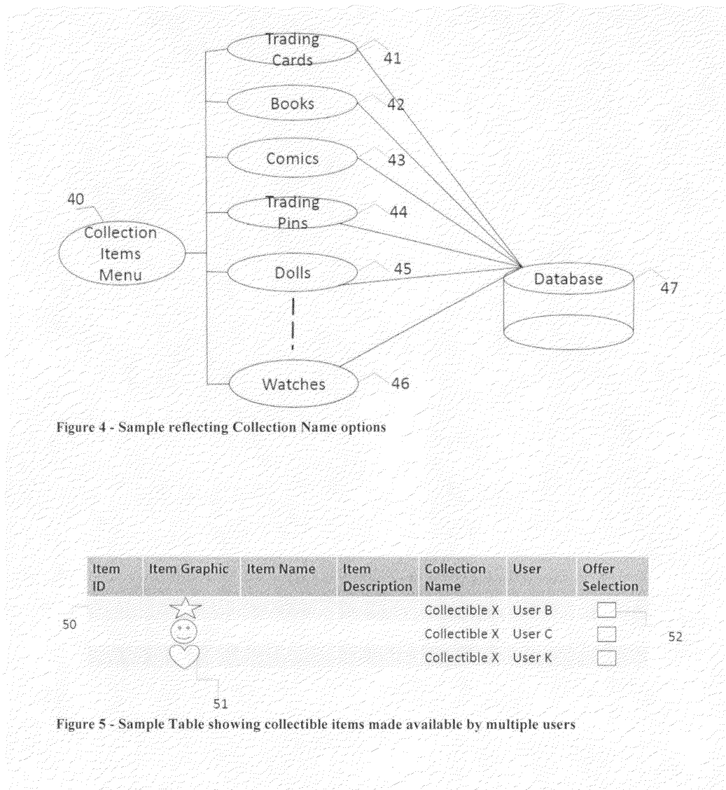

FIG. 4, shows a sample breakout of the CIM 41-46. By selecting a Collection Name, the collection selected becomes the default collection name. FIG. 4, also provides a database 47 for storing all usernames, passwords and transactions.

FIG. 5, shows a list of All-Offers 50, where all CIL items for trade/exchange identified by users of the present invention are presented. A user is able to select a desired item 52, and begin the process of proposing a trade/exchange.

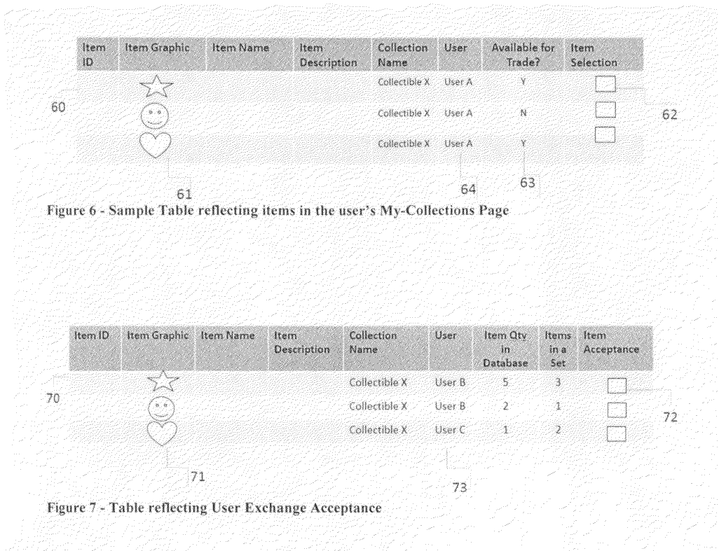

Referring to FIG. 6, users are able to view their personal collection profile, reflecting their current personal holdings online; additionally, the user 64 is able to update an item's availability for trade 63 with a Y or N by toggling the item selection 62;

Referring to FIG. 7, both users/partners of an exchange are able upon satisfactory exchange of an item, clicks on their respective Item-Acceptance 72 selectors, indicating the conclusion of the exchange process between the users. This ensures that both users are satisfied. Additionally, the present invention automatically updates the user personal collection profiles, reflecting the completed exchange between the parties.

While the invention has been described with reference to the preferred embodiment thereof, it is apparent that changes may be made to the components and their arrangements without departing from the scope of the invention as hereafter claimed. It is also to be understood that the following claims are intended to cover both the specific and generic features of the embodiment.

What is claimed:

1. A system and method of trading and exchanging collectible items between users, comprising of:
a. Connectivity of users to the present invention via any available Internet connection means, including but not limited to computers, telephones/smartphones, notebooks, notepads, mobile Apps, etc.;
b. Registration of new users wherein the registered user gains access to the present invention's internet based service;
c. User exchanges collectible items with other collectors;

2. A method according to claim 1, wherein, the logged in user is presented with the Home/Landing page, wherein, existing collectible items are listed on a Collection Items List (CIL), including their names, description, quantity, and associated graphic image;
a. Whereby a user is able to establish and view their own personal collection profile, reflecting their own personal holdings in their possession;
b. Whereby users may select items from the CIL, to be added to their personal collection profile;
c. Whereby users may remove items for their collection profile by selecting the appropriate item and clicking the delete button associated with that item.
d. Whereby users are able to update an item's availability for trade with a Y or N by toggling the item selection;

3. A method according to claim 1, whereby authenticated users are presented with menus of selectable items called the Collectable Items Menu (CIM);
a. whereby users may display a Profile page, which enables them to set user preferences; including reset password, change default Collection Name, establish restrictions to personal collection display, and setup payment method;
b. whereby users may search using keywords, search the collections database for targeted output;
c. whereby users display collection items to reflect the popularity of such collectible items;
d. Further whereby users are able to complete a submission form and propose new collection items for addition to the CIL as well as new additions to the CIM;

4. The method according to claim 1, whereby users are able to execute a trade between each other regardless of their geographic location;
a. Whereby a user (ex, userA) is able to view a display of available collectible items from other users (ex. userB);
b. Whereby said userA may select said item belonging to userB;
c. Whereby said userA is able to identify item(s) from said userA's personal collection profile and propose an exchange to userB; wherein said items for exchange are temporarily held in a shopping cart;
d. Whereby an email is sent automatically to both userA and userB reflecting an offer for exchange, as well as reflect the results on the pending offers page;
e. Whereby userB reviews available offers for exchange and accepts a choice;
f. Whereby userA is notified of the acceptance by userB, via email with shipping/delivery instructions as well as the action reflected on the pending offers page;
g. Whereby after the exchange between users, both userA and userB are able to click on their respective item acceptance buttons, verifying the conclusion of the exchange process, thus ensuring that both users are satisfied with the trade;
h. Whereby the personal collection profiles of both users are automatically updated once both acceptances are executed.
i. Whereby a user is able to restrict or expose their personal collection to other users within the trading environment from their user profile as desired;
j. Still another feature is to enable users to view their trading history.

5. A method according to claim 2, whereby users are able to enter comments on a blog associated with each item of the CIL;
a. whereby these comments are made available to all users;
b. whereby measures to redact inappropriate inputs are incorporated; and
c. whereby the accounts of abusive users are terminated;

6. A method in accordance with claim 4, whereby a five series of rating is incorporated, wherein users are able to rate the transaction experience with other users.
